(19) United States
(12) Patent Application Publication
(10) Pub. No.: US 2002/0081038 A1
(43) Pub. Date: Jun. 27, 2002

(54) Graphic image coding

(75) Inventor: John T.P. Moule, Bristol (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/023,070

(22) Filed: Dec. 17, 2001

(30) Foreign Application Priority Data
Dec. 27, 2000 (GB) 0031605.9

(51) Int. Cl. G06K 9/36

(52) U.S. Cl. 382/245

(57) ABSTRACT

An image encoding apparatus (FIG. 4) is configured to receive data defining respective colour values for pixels arranged in rows and columns (FIGS. 1 and 2) to make up an image. The apparatus being applies coding for the pixel color values, suitably through run-length encoding, to provide image compression. The apparatus is configured to encode images as either sequential rows or sequential columns of pixel data, in dependence on which direction requires less storage. A reconfiguration of the apparatus (FIG. 4), as a decoder for such compressed images, is also provided.

The present invention relates to methods and apparatus for the encoding of image data and, in particular, for the handling of data specifying data in the form of rows and columns of pixel colour values.

More and more consumer electronics appliances are gaining graphical user interfaces requiring the embedded storage of graphical assets, or images, to present an aesthetic on-screen display. Efficient storage of these images is essential if the memory requirements of display materials is not to become an unacceptable overhead. To achieve such a reduction, image compression is used.

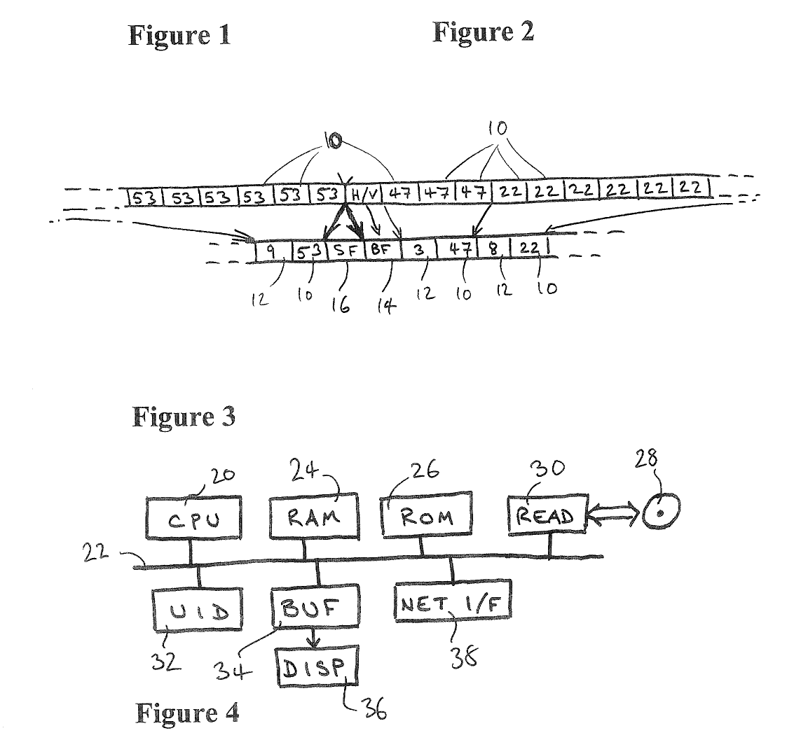

Run length encoding (RLE) is a technique used widely in image compression. As will be readily understood, an RLE algorithm determines the number of contiguous pixels of the same colour and stores this count along with the pixel colour. This is done in a scanning fashion, row by row. Images that contain contiguous pixels in a row-wise fashion, as illustrated in FIG. 1 of the attached drawings, achieve the best compression ratios. However, where the image contains contiguous pixels ordered in a column-wise fashion, as illustrated in FIG. 2, problems arise. The standard RLE row-wise encoding algorithm cannot cope with this and a sub-optimal compression ratio is achieved.

U.S. Pat. No. 5,748,904 to Huang et al describes a method and system for compressing graphic data by dividing the data into segments of programmable size. Each segment of the graphic data is compressed by three different algorithms that encode the graphic data as a plurality of code words, with a header being provided in the encoded image data to indicate the number of code words and the compression method used in each code word. The total number of bytes obtained from the compression of a segment is compared to a pre-defined limit to identify whether pre-determined criteria for the success of compression have been met and, if so, a flag is set to indicate that a segment has been compressed.

Such a method and apparatus may well be result in reduction of the storage space required for a given image, but it is at the expense of increased or enhanced processor capabilities required to implement the three algorithms. The present applicants have recognised that such an approach is unsuited to devices having restrictions as to processor capability, for example portable telephones, personal digital assistants (PDA's), and personal/portable computers.

It is therefore an object of the present invention to provide a system for the handling of image data, whether encoding or decoding, which is relatively simple yet effective to implement.

In accordance with a first aspect of the present invention there is provided an image encoding apparatus configured to receive data defining respective colour values for pixels arranged in rows and columns to make up said image, said apparatus being arranged to apply coding for pixels to provide image compression, wherein said apparatus is configured to encode said image as either sequential rows or columns, in dependance on which requires less storage. By applying the relatively simple (and not overly processor demanding) test as to whether row-wise or column-wise encoding gives the better data compression, a reduction in the volume of stored data may be achieved for a reasonable processing overhead.

Such an apparatus is suitably configured to apply run-length coding for runs of pixels having the same colour value to provide image compression. Alternatively, or in addition, such apparatus may be configured to apply run-length coding in row-wise and column-wise directions and be configured to store the encoded data for whichever orientation requires less overall data to store a resulting compressed image.

The apparatus may be further configured to include in the data an indicator as to the coding direction, row or column, utilised. Such an indicator may be a one bit flag indicating, in one setting, that row-based coding has been utilised and, in its other setting, that column-based coding has been utilised.

Also in accordance with the present invention, there is provided a method of encoding image data when specified as respective colour values for pixels arranged in rows and columns, comprising determination as to whether image compression through sequential row-wise or column-wise image coding requires fewer data bits for storage of the resulting encoded image. Such a method may include run-length coding for runs of pixels having the same colour value in the row or column direction, as selected. Such a method may further include the step of including an indication in the encoded image data as to the selected coding direction.

In accordance with a further aspect of the present invention, there is provided a decoder apparatus configured, on receiving an image encoded according to the method recited above, to determine whether row-wise or column-wise coding has been applied, and to apply the appropriate decoding to recreate an image. Such a decoder apparatus may be further configured to identify, in a data stream comprising an encoded image, a data flag and the setting thereof to identify the direction of the coding applied.

Also in accordance with the present invention there is provided a removable data carrier holding data defining at least one encoded pixel image, said image being run-length encoded as to pixel colour values in whichever of the row-wise and column-wise direction requires the fewer data bits.

Still further in accordance with the present invention there is provided a data signal carrying data specifying at least one encoded pixel image run-length encoded as to pixel colour values in whichever of the row-wise and column-wise direction requires the fewer data bits, said signal further including a data flag identifying the encoding direction, whether row-wise or column-wise.

By using the encoding method and apparatus of the present invention, the image file size (the volume of data required for storage) for the image of FIG. 2 can be reduced to that of FIG. 1 by compressing using a column-wise encoding scheme rather than a row-wise one.

Further features and advantages will become apparent from reading of the following description of preferred embodiment of the present invention, given by way of example only and with reference to the accompanying drawings, in which:

FIGS. 1 and 2 are example pixel images having respectively a predominance of horizontal and vertical pixel contiguous colour value runs;

FIG. 3 schematically illustrates the principle of run-length coding;

FIG. 4 is a block schematic diagram of a data processing apparatus suitable for configuration as an encoder or decoder apparatus embodying the present invention;

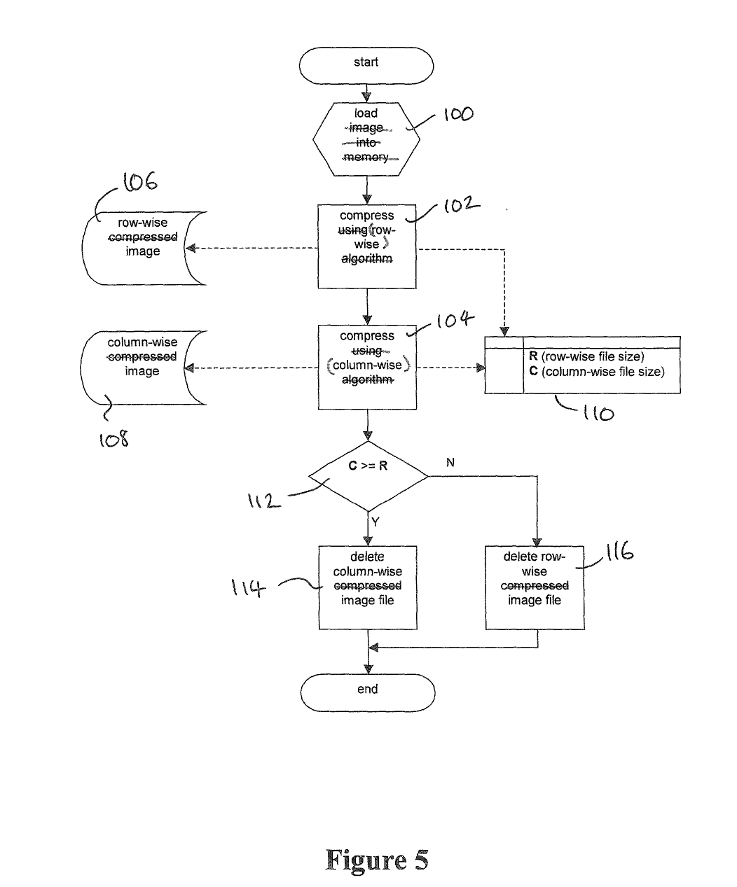

FIG. 5 is a flow chart representing steps of an encoding algorithm embodying the present invention; and

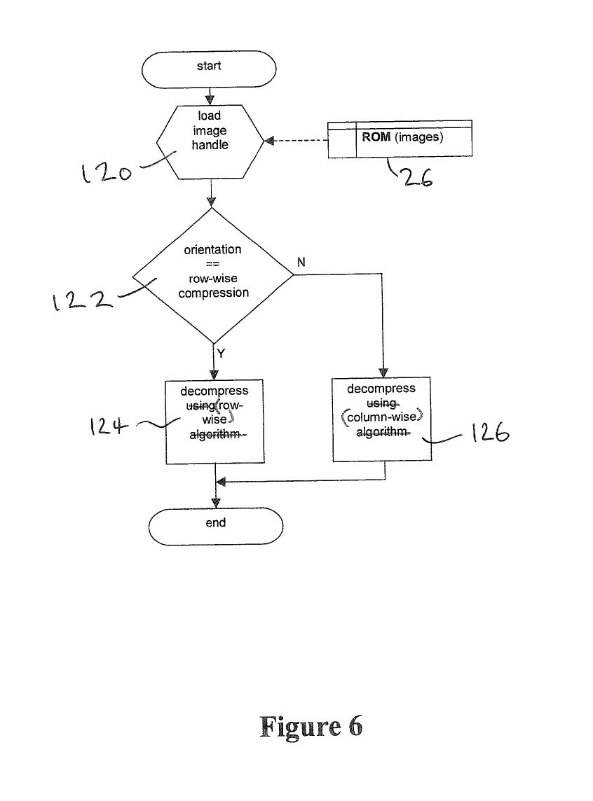

FIG. 6 is a flow chart representing steps of a decoding algorithm embodying the present invention.

The present invention is based on a methodology whereby, to achieve an improved compression ratio the image is encoded twice—once in a row-wise scanning fashion and again in a column-wise scanning fashion. The two resulting file sizes are then compared and the best one (i.e. the smallest in terms of the number of required bits) is stored. The savings from choosing the better of horizontal or vertical RLE are illustrated by considering applying horizontal RLE to the bitmap images of FIGS. 1 and 2. The image of FIG. 1 may be compressed by horizontal RLE to 1,604 bytes whereas horizontal RLE applied to the image of FIG. 2 gives a compressed value of 5,548 bytes —greater than three times the result for the image of FIG. 1. By selecting the correct (or most economic) orientation, valuable savings in required data storage may be achieved.

The principals of run-length encoding are schematically illustrated in FIG. 3 which represents a sequence of pixels having respective colour values. The upper part of the figure represents the sequence of colour values 10 (one per pixel) with the lower part representing the encoded form having respective groupings comprised of a number 12 indicating the run length followed by a colour value 10 pertaining to all pixels of that run.

When compressing the image, the encoding orientation must be recorded. This is suitably achieved with a Boolean flag BF indicating row or column-wise encoding, as indicated at 14 in FIG. 3 following a start of image SF indicator 16 in the encoded stream. On decompression the BF orientation flag is queried to reveal whether row or column decoding is necessary.

Using the above compression approach incurs an overhead—namely that compressing requires two passes, while decompressing only requires one. This is not a problem because the compression process is typically done at compilation time, when the images are burnt into ROM or otherwise stored. The only slight overhead incurred at runtime is in deciding the decoding orientation, which is minimal. The main advantage is in the improved compression ratio achieved.

FIG. 4 is a block schematic diagram of apparatus suitable for configuration as an image encoding apparatus, according to respective aspects of the present invention. The apparatus comprises a processor CPU 20 connected via address and data bus 22 to random access and read only storage RAM 24, ROM 26, together with a further storage means for offline data, such as a CD-ROM 28 accessed via a suitably configured reader 30. Also coupled to the CPU 20 via the bus 22 are various user input devices 32 (such as a keyboard, mouse or joystick), an image buffer 34 (for the accumulation of output pixel data for presentation on display 36) and an interface 38 to further external data sources such as the internet.

The configuration of the apparatus as encoder or decoder may be down to software run by CPU 20 and loaded up from one of the memories 24, 26 or external data sources 28, 38, although hardware configuration as one or the other is not ruled out. As an encoder, the CPU 20 receives data defining respective colour values for pixels arranged in rows and columns to make up an image. The CPU 20 takes the data from sources 24,30,32 or 38 and selectively encodes it as either sequential rows or sequential columns of pixel data, in dependence on which direction requires less storage for the encoded image data in, for example, RAM 24.

When configured as a decoder apparatus, the CPU 20 may read the encoded pixel data from disc 28 via reader 30 and temporarily store it in RAM 24 for processing, during which the short frame SF 16, Boolean flag BF 14, run length 12 and colour value 10 data fields are read and processed to enable the CPU 20 to recreate the image. On recreation, the image pixels are stored in buffer 34 until a complete frame has been assembled for output to display 36.

The flow chart in FIG. 5 shows a high level view of the compression algorithm applied by the host system of FIG. 4, typically, a PC or similar.

Walking through the flow, the source image to be compressed is loaded into memory, at 100. It is then compressed twice, using row-wise 102 and column-wise 104 algorithms to respectively create row-wise 106 and column-wise 108 compressed images. The compression orientation flag is set appropriately in each case. The resulting compressed images are written to file and the file sizes stored in RAM; R and C, as indicated at 110.

A selection 112 then determines which is the larger of the two values R and C. If the column-wise compressed image file C is larger this indicates that compression of the source image is more suited to row-wise compression. The column-wise compressed image file is then deleted 114, leaving a row-wise compressed image file. The converse occurs if the column-wise C compressed image file is smaller, with the row-wise compressed image file being deleted, at 116.

The flow chart in FIG. 6 shows a high level view of the decompression algorithm applied by a suitably configured host system, such as that of FIG. 4. The decompression of images is done on the target system—for example a CE device (such as a DVD player).

Walking through the flow, a handle to the compressed image is retrieved at 120 from ROM 26. A selection 122 then determines the compression orientation and the appropriate decompressor (row-wise at 124, column at 126) is used to decompress the image.

From reading of the foregoing, it will be understood that the present invention is not limited to the specific embodiments described hereinabove, and that further or alternative components, features, and/or functionalities, as will readily suggest themselves to the skilled practitioner, may be employed in place of the components, features or functionalities described hereinabove. Whilst the scope of the present invention is defined by the claims appended hereto, the applicants hereby give notice that further claims may be formulated directed to any novel feature or combination of features described herein.

1. Image encoding apparatus configured to receive data defining respective colour values for pixels arranged in rows and columns to make up said image, said apparatus being arranged to apply coding for pixels to provide image compression, wherein said apparatus is configured to encode said image as either sequential rows or sequential columns of pixel data, in dependence on which direction requires less storage.

2. Apparatus as claimed in claim 1, being configured to apply run-length coding for runs of pixels having the same colour value to provide image compression.

3. Apparatus as claimed in claim 2, being configured to apply run-length coding in row-wise and column-wise direction and to store the encoded data for whichever orientation requires less overall data.

4. Apparatus as claimed in claim 1, being further configured to include in said data an indicator as to the coding direction, row or column, utilised.

5. Apparatus as claimed in claim 4, wherein said indicator is a one bit flag indicating, in one setting, that row-based coding has been utilised and, in its other setting, that column-based coding has been utilised.

6. A method of encoding image data when specified as respective colour values for pixels arranged in rows and columns, comprising determination as to whether image compression through sequential row-wise or column-wise image coding requires fewer data bits for storage of the resulting encoded image.

7. A method as claimed in claim 6, including run-length coding for runs of pixels having the same colour value in the row or column direction, as selected.

8. A method as claimed in claim 6, including the step of including an indication in the encoded image data as to the selected coding direction.

9. A decoder apparatus configured, on receiving an image encoded according to the method of claim 6, to determine whether row-wise or column-wise coding has been applied, and to apply the appropriate decoding to recreate an image.

10. A decoder apparatus as claimed in claim 9, being further configured to identify, in a data stream comprising an encoded image, a data flag and the setting thereof to identify the direction of the coding applied.

11. A removable data carrier holding data defining at least one encoded pixel image, said image being run-length encoded as to pixel colour values in whichever of the row-wise and column-wise direction requires the fewer data bits.

12. A data signal carrying data specifying at least one encoded pixel image run-length encoded as to pixel colour values in whichever of the row-wise and column-wise direction requires the fewer data bits, said signal further including a data flag identifying the encoding direction, whether row-wise or column-wise.
